(19) United States
(12) Patent Application Publication
(10) Pub. No.: US 2003/0070255 A1
(43) Pub. Date: Apr. 17, 2003

(54) Hydraulic door closer

(76) Inventor: Jack Huang, Taoyuan (TW)

Correspondence Address: Keith Kline, PRO-TECHTOR INTERNATIONAL SERVICES, 20775 Norada Court, Saratoga, CA, 95070-3018, US

(21) Appl. No.: 09/982,843

(22) Filed: Oct. 16, 2001

(51) Int. Cl. E05F 3/04

(52) U.S. Cl. 16/60

(57) ABSTRACT

The present invention relates to an improved structure of hydraulic door closer for easier operation and effectively eliminate oil leakage that allows fast adjustment of the of the spring load to the status of expected door closing speed by having provided on one connecting rod in a linkage base a pressure regulation mechanism for varying spring load, and having a rotation rod used to drive the spring in said mechanism to forthwith expose outside a flange of a hydraulic cylinder so to facilitate spring load regulation directly by turning of the rotation rod.

### BACKGROUND OF THE INVENTION

(a) Field of the Invention

The present invention related to an improved structure of hydraulic door closer, and more particularly, to one that allows fast and precise regulation of spring load to a closing speed as expected.

(b) Description of the Prior Art

The hydraulic door closer of the prior art is essentially comprised of a case fixed to a doorframe. The doorframe contains a hydraulically operated linkage base. One side of the linkage base is connected to a pair of connecting rods disposed in parallel with their ends further connected to a piston for respectively inserted into a corresponding hydraulic cylinder which is connected through a cylinder chamber. A spring is inserted between said connecting rods and said piston, and a through hole is provided between two hydraulic cylinders for the hydraulic oil to circulate between said two hydraulic cylinders. A pivot to operate a door panel is provided at the center of the linkage base. Accordingly, once the door panel is pushed (or pulled) to open, said two connecting rods in the linkage base respectively move in opposite direction in its own hydraulic cylinder at the same time as the linkage base turns. When the push (pull) force against the door panel is released, the linkage base returns the door panel to its closed position as said both connecting rods are restored by spring load. During the door panel is being opened or closed, the hydraulic oil flows between said two hydraulic cylinders to secure a firm door opening or closing speed.

Since said door closer executes the closing by the restoration of the spring load, a door closer operates by regulating the spring load to vary the force of said restoration of the spring load is generally available in the market. Said door closer is essentially comprised of a plate linked to a regulating rod is provided inside the case to either compress or release the spring load by displacement of the plate, thus to regulate the door closing speed. However, a mechanism used to regulate the spring load of the prior art is very complicate in structure and vulnerable to oil leakage. Within the mechanism, two springs are used. Loads of said two springs are simultaneously varied when a pressure-regulating rod is turned. When the door panel is closing, either spring to the rod is prevented from fully extended as restricted by the fixed doorframe. Therefore the mechanism fails to completely regulate both of said springs to a well-balanced status and further to make it more difficult to regulate the spring load.

### SUMMARY OF THE INVENTION

The primary purpose of the present invention is to provide an improved structure of a hydraulic door closer that allows fast and precise regulation of spring load to the expected speed to close the door panel by having the spring load regulation mechanism provided to either connecting rod inside a linkage base to regulate the spring load only on the spring on that connecting rod.

Another purpose of the present invention is to provide an improved structure of a hydraulic door closer that allows easy regulation of the spring load. To achieve the purpose, a rotation rod to drive spring load is directly exposed outside a flange of the hydraulic cylinder so that the spring load can be directly adjusted by turning the rotation rod.

Another purpose yet of the present invention is to provide an improved structure of a hydraulic door closer that effectively eliminate leakage of hydraulic oil since the regulation of spring load is done by the portion of the rotation rod that drives spring load exposed outside the flange of the hydraulic cylinder.

### BRIEF DESCRIPTION OF THE DRAWINGS

FIG. 1 is an exploded view of a preferred embodiment of the present invention;

FIG. 2 is a sectional view of the preferred embodiment of the present invention;

FIG. 3 is an exploded view of a pressure regulation mechanism in the preferred embodiment of the present invention; and

FIG. 4 is a schematic view of a throttle in the preferred embodiment of the present invention.

### DETAILED DESCRIPTION OF THE PREFERRED EMBODIMENTS

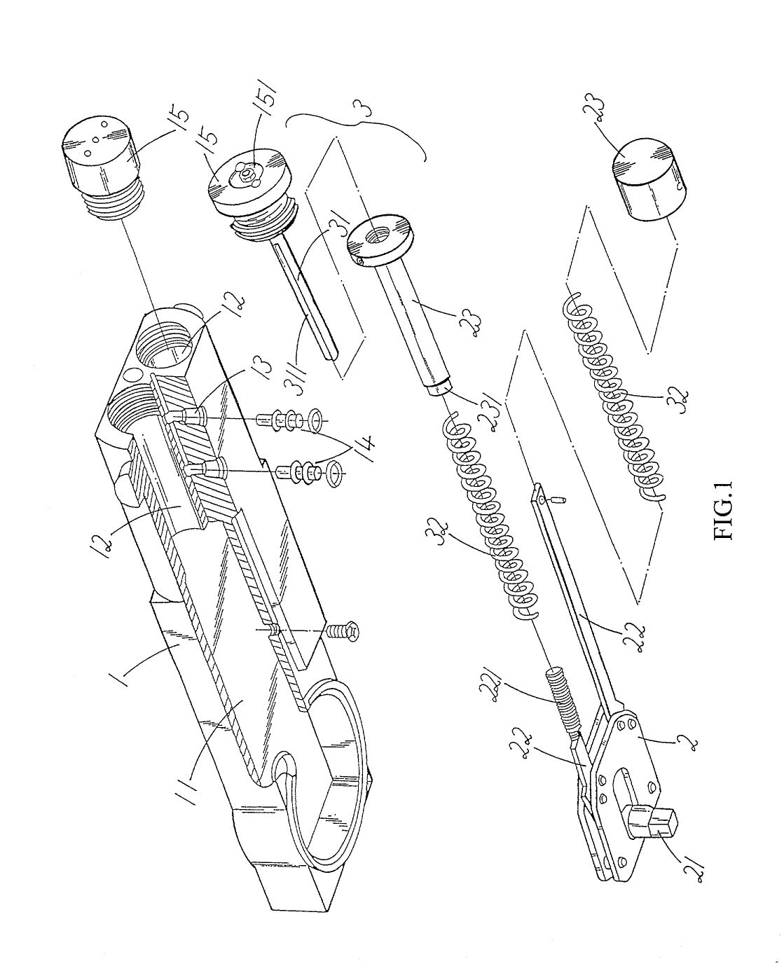

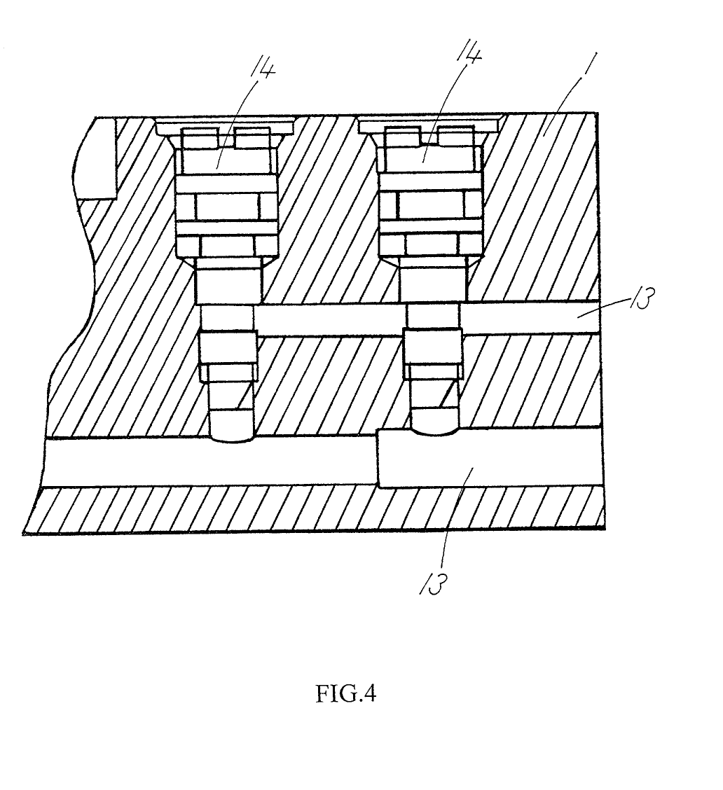

Referring to FIG. 1, a preferred embodiment of an improved structure of hydraulic door closer of the present invention is essentially comprised of a case (1) fixed to a doorframe. The case (1) contains a hydraulic chamber (11) and a linkage base (2). One side of the linkage base (2) is connected to a pair of connecting rods (22) disposed in parallel and another end of each connecting rod (22) is further connected to a piston (23) to be inserted into a hydraulic cylinder (12) which is connected through the hydraulic chamber (11) hand a flange (15) is provided on the end of the hydraulic cylinder (12) to seal the hydraulic cylinder (12). A spring (32) is provided between the connecting rod (22) and the piston (23) and a through hole (13) is provided between said two hydraulic cylinders (12) for hydraulic oil to circulate between said two hydraulic cylinders (12). A throttle (14) is provided to each through hole (13) to help control the flow of the hydraulic oil as illustrated in FIG. 4.

A pivot (21) is provided at the center of the linkage base (2) to drive the operation of a door panel. When the door panel is pushed (pulled) to open, said two connecting rods operate in opposite direction in the hydraulic cylinders (12) relatively to the turning by the linkage base (2). Once the door panel is released, restoration of the springs (32) of said two connecting rods (22) forces the linkage base (2) to return the door panel to its closed status. During the opening/closing, the hydraulic oil flows between said two hydraulic cylinders (12) via said two through holes (13) to secure a steady opening/closing speed.

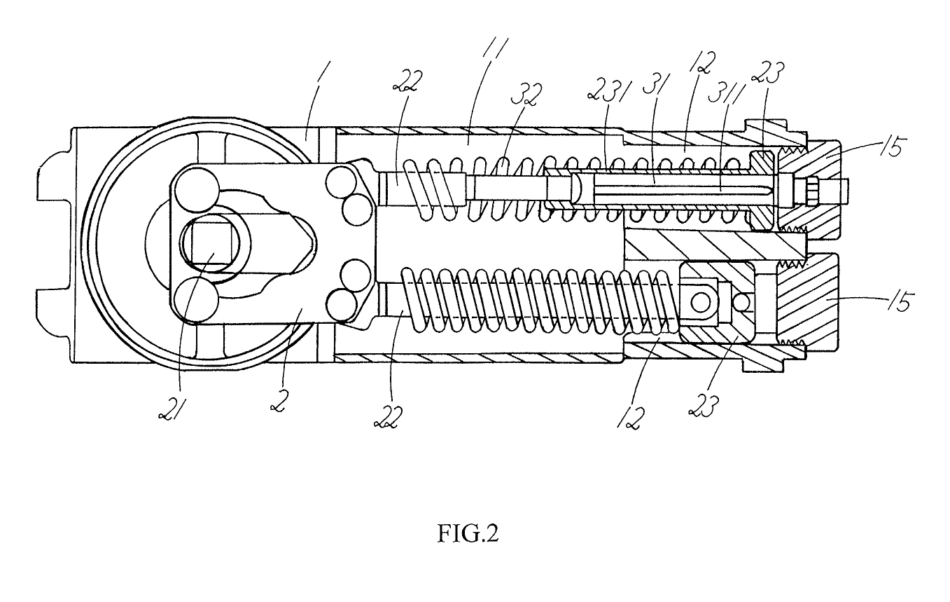

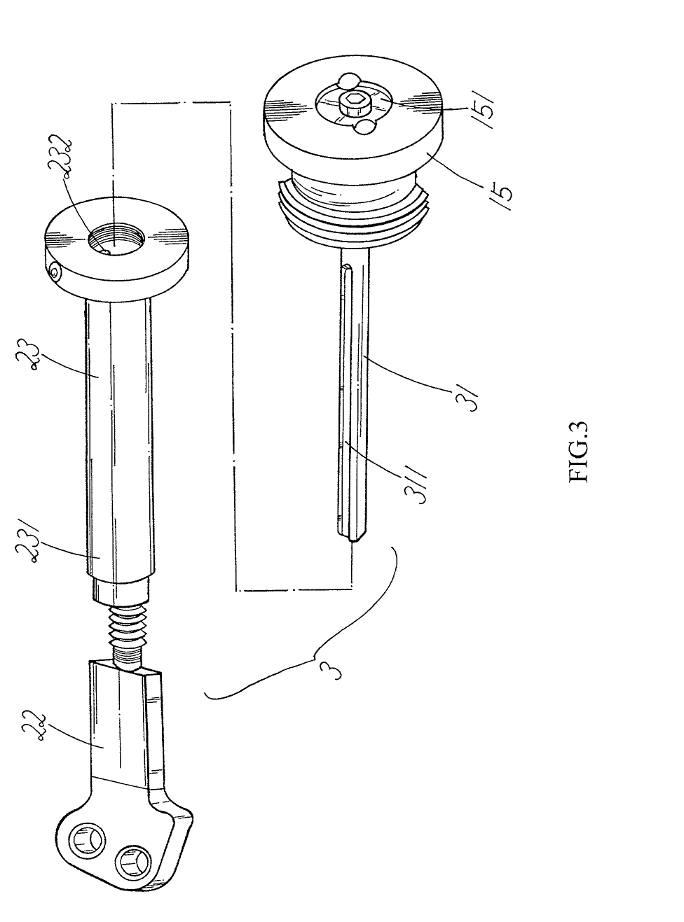

Referring to FIGS. 1, 2 and 3, a mechanism (3) to vary the load of the spring (32) is provided on either connecting rod (22) in the linkage base (2). Within, a rotation rod (31) for a user to turn is provided to the regulation mechanism (3) for the spring load. Said rotation rod (31) related to a straight rod has at its one end fixed in an insertion hole (151) formed at the center of the flange (15) and rotates when turned by the user. The other end of the rotation rod (31) is inserted into the piston (23). One end of the piston (23) in relation to the other end of the rotation rod (31) is screw joined with the connecting rod (22). A threaded sleeve (231) and a threaded section (221) are respectively provided on the screw joint ends of the piston (23) and the connecting rod (22). A slot (311) parallel with the hydraulic cylinder (12) is formed on the rotation rod (31) and nipple (232) to stick into the slot (311) is provided on the piston (23) at where in the rotation rod (31) is inserted into the piston (23). When the rotation rod (31) is turned, the nipple (232) restricted in the slot (311) drives the piston (23) to more it either toward one end of or away from the linkage base (2). The movement of the piston (23) varies the load of the spring (32) provided between the piston (23) and the linkage base (2), thus to vary the restoration of the linkage base (2) for achieving the purpose of adjusting the closing speed of the door panel. Referring to FIG. 4 again, when the rotation rod (31) is turned to vary the spring load thus to change the restoration force of the linkage base (2), the flow from the throttle (14) is also adjusted in conjunction with the changed speed of the hydraulic oil circulating between two hydraulic cylinders (12) to help regulate the closing speed of the door panel.

An improved structure of hydraulic door closer of the present invention by having a pressure regulation mechanism disposed on either connecting rod in a linkage base to execute adjustment of the load of a spring on the connecting rod for fast and precise adjustment of the spring load to the status of expected closing speed for a door panel and achieving the regulation of the spring load simply by turning the rotation exposed out of a flange of the hydraulic cylinder provides easier operation of the door closer and effectively eliminates leakage of hydraulic oil. Therefore, this application for utility patent is duly filed.

I claim:

1. An improved structure of hydraulic door closer, essentially comprised of a case fixed to a doorframe, the case containing a hydraulic chamber and a linkage base, one side of the linkage base being connected to a pair of connecting rods in parallel; the end of each connecting rod being connected to a piston for respectively inserted into the hydraulic cylinder connected through the hydraulic chamber, a flange being provided at the end of the hydraulic cylinder to seal the hydraulic cylinder;
a spring inserted by the connecting rod being provided between the connecting rod and the piston, a through hole being provided at the center of the linkage base to drive a pivot to open or close a door panel; both connecting rods in the case moving in opposite direction as the linkage base being turned to open up the door panel, and the released door panel causing both connecting rods to restore to close the door panel while hydraulic oil circulating between two hydraulic cylinders to form a steady opening/closing speed of the door panel; characterized by that:
a pressure regulating mechanism being provided at either connecting rod, a rotation rod for a user to turn around for regulating spring load being provided to the regulating mechanism, one end of the rotation rod being inserted and positioned in a hole formed at the center of the flange and the other end being inserted into the piston, one end in relation to the other end of the rotation rod being screw joined the connecting rod, a straight slot in parallel with the hydraulic cylinder being formed on the rotation rod, a nipple at where the rotation rod being inserted into the piston to be restricted by the slot to turn the piston in conjunction with the turning by the rotation rod for moving the piston either toward or away from the lin a e base, and the sprin load between the piston and the lin a e bein chan ed to vary restoration force of the lin a e base for achievin the purpose of re-adjustin the closin speed of the door panel.

2. An improved structure of hydraulic door closer as claimed in claim 1, wherein, the piston and the connectin rod are respectively formed at their joint ends threaded sleeve and threaded rod.

3. An improved structure of hydraulic door closer as claimed in claim 1, wherein, said throu h hole is provided with a throttle.
